(19) United States
(12) Patent Application Publication
(10) Pub. No.: US 2025/0362214 A1
(43) Pub. Date: Nov. 27, 2025

(54) METHOD AND DEVICE FOR MEASURING OF VISCOSITY

(71) Applicant: AMT-SYSTEMS OY, Joensuu (FI)

(72) Inventor: Heikki MUSTALAHTI, Hyvinkaa (FI)

(73) Assignee: AMT-SYSTEMS OY, Joensuu (FI)

(21) Appl. No.: 19/298,202

(22) Filed: Aug. 13, 2025

Related U.S. Application Data
(63) Continuation-in-part of application No. PCT/FI2024/000003, filed on Feb. 15, 2024.

(30) Foreign Application Priority Data
Feb. 17, 2023 (FI) 20230010

(51) Int. Cl. G01N 11/04

(52) U.S. Cl. CPC G01N 11/04

(57) ABSTRACT

The invention relates to a method and device for measuring viscosity. A sample from a process tube (4) is drawn into a measuring unit (2) via a measurement capillary (1) or a gap or hole in the tube wall (5). The measuring unit (2) is located outside the wall (5). A sample is taken automatically by underpressure generated by a piston (3) moving within a cylinder (6). Viscosity is measured during the piston's opposite motion, which returns the sample to the process through the same measurement capillary, gap, or hole. The device includes a sampling/measurement capillary tube (1) and a measuring unit (2) comprising a cylinder (6) and a piston (3). The cylinder (6) is positioned at a gap or hole in the wall (5) to take a sample, measure viscosity, and return the sample, with the measurement capillary, gap, or hole serving as the sampling path.

### BACKGROUND OF THE INVENTION

The invention relates to a method for measuring of viscosity, in which method, a sample of liquid, solution or equivalent being examined is run by means of a pressure difference from a process tube, tank or equivalent through a measurement capillary to a measuring unit, and the measurement of viscosity is performed by an opposite motion. Furthermore, the invention relates to a device for measuring of viscosity, which device includes a sampling/measurement capillary tube and a measuring unit consisting of a cylinder and a piston.

The determination of viscosity of various liquids, oils and solutions containing solid particles is a substantial part of managing the processes of these materials. Viscosity can be represented to describe the flow resistance of liquid, solution or equivalents. Viscosity is one of the so-called transport quantities because it affects the migration of material, i.e. diffusion, in a medium. Viscosity is determined by means of viscometers.

The measurement of capillary viscosity is recognized to be the closest to the values of absolute viscosity and thus a method that is the most reliable and containing the fewest sources of error when it is taken care of that the flow in the capillary is not turbulent. This is easy to achieve by means of a capillary of suitable size. When the measurement utilises a wide pressure range, viscosity can be determined within a wide shear rate range and/or at a preferred shear rate. This is very helpful when resolving various process issues because changes in viscosity in a wide shear range reveal the performance of the material being measured in different process conditions.

Currently, there are online and inline viscometers which operate either in very specific applications due to the technology used and/or they include various sources of error or separate samplers. Such are, inter alia, measurements based on the performance of different frequencies of vibration or sound which have to utilise correcting factors. This is why these measurements are unreliable in many applications, particularly when the material being measured is a mixture of solution and particles. The current online measurements require frequent calibrations and they typically operate within only one or a very narrow shear rate range, whereby they offer very little assistance in problem situations of processes.

The rates of processes increase because of requirements to intensify production. Due to this, the flows of materials flowing in various steps of the processes increase and, similarly, the shear rates increase. As the conditions become more difficult, possible runnability and quality issues of the processes are also emphasised and, on the other hand, the significance of managing the processes increases.

The existing online capillary viscometers have not become more common because they are very expensive and require either a separate sampling tube with valves or an expensive sampler. Additionally, their construction is complex and they require service when they are used, which incurs costs.

### SUMMARY OF THE INVENTION

An object of the invention is to disclose a method and a device for measuring viscosity, which eliminate disadvantages related to the measurement of viscosity. A particular object of the invention is to introduce a method and a device which provide reliable and accurate measuring results. Additionally, an object is to provide a method and a device which have very good repeatability of measurements. A further object of the invention is to introduce a device with a simple construction and which is cost-effective to manufacture and easily serviceable.

The object of the invention is achieved with a method and a device for measuring viscosity, which are characterised by what is presented in the claims.

The method for measuring viscosity according to the invention is characterised by locating a measuring unit outside the wall of a process tube or tank or equivalent, taking a sample automatically via a measurement capillary or slit or hole extending through the process tube, tank or equivalent directly from the process tube or tank or some other part of the process cycle by means of underpressure caused by the motion of a piston in a cylinder to the cylinder, and performing the measurement of viscosity by an opposite motion of the piston, whereby the taken sample is returned to the process via the same measurement capillary or slit or hole. In this case, one measurement capillary or one hole or slit opened to the wall of the process tank, tube or equivalent operates as both a sampling tube and a measurement capillary tube.

In another advantageous application of the invention, the device is cleaned in connection with process cleaning. Then, there is no need for a separate cleaning solution or automatics or e.g. valves.

The device for measuring viscosity according to the invention is characterised by that a cylinder is fastened at the point of a slit or hole manufactured to the wall of a process tube, tank or equivalent, extending through the wall, outside the wall and arranged to take a sample by means of underpressure caused by a motion of a piston via a sampling/measurement capillary tube or slit or hole extending through the wall directly out of the process tube or tank or equivalent, arranged to measure viscosity and to return the sample via the sampling/measurement capillary tube or slit or hole and that the sampling/measurement capillary tube or slit or hole extending through the wall is arranged to operate as the sampling/measurement capillary tube.

### DETAILED DESCRIPTION

The measurement takes place such that, initially, the piston of the cylinder of the measuring unit is fast to the sampling/measurement tube or hole or slit of the process tube, tank or equivalent. The piston is started to be pulled away from the wall of the process tube or tank, whereby underpressure is created in the cylinder, which provides, together with the pressure in the process tube or tank, that the material being measured flows to the cylinder. The viscosities of most applications, inter alia, nano cellulosic solutions, are high, due to which, the piston must be pulled very slowly in order to obtain it to the cylinder without air infiltration being able to go past sealings due to high underpressure. Typically, the pull lasts for minutes or, in case of very high viscosities, even longer. In the measurements, the material being measured is returned back via the same sampling/measurement tube, hole or slit. The measurements typically utilise the pressure of e.g. from 0.1 MPa to even dozens of MPa, whereby a typical measurement lasts no more than seconds due to the high pressure.

The basic idea of this invention is that one single tube, hole or slit manufactured to the wall of a process tube, tank or equivalent, extending through the wall, is used for both sampling and measurement, whereby the same tube, hole or slit operates as a capillary when the sample is returned back through the wall to the process tube or tank or equivalent. In this case, the device does not require a separate sampling tube or device or a separate measurement capillary or mechanics with valves required by them. The measuring results obtained by the method and device are reliable and accurate and the repeatability of measurements is good.

The presented method and device are simple and the device is cost-effective to manufacture. It has many advantages. The device does not require any valves. Due to its simple construction, service is rarely needed and the service is easy and quick to perform. If the device is detached from the tank or the tube, the hole in the tube can be blocked manually or by a separate automatic plug, or it includes one single valve, by means of which, the device is disconnected from the process e.g. for the duration of the service. When the device is simple and it does not include separate closable tubes, valves or samplers, it does not need its own separate cleaning system but the device is cleaned in connection with process cleaning. Therein, process automation announces that the process cleaning is starting, whereby the device starts a cleaning program wherein the device takes process cleaning solutions to its cylinder and removes them back to the process. Due to this, there is no need for separate samplers or cleaning-solution treatment apparatuses, either.

The device connects to the process via a small hole or slit required by the capillary, whereby the device can be serviced or replaced easily because only a little process solution or mass comes out through e.g. the hole in the process tank. If required, the hole or the slit can be covered for the duration of the service by e.g. a plate.

The device can measure viscosity in one specific shear rate and/or within a wide range of shear rates. The apparatus can measure viscosity in a wide shear rate range typically from hundreds even to millions of s−1 if the utilised measuring pressure range is wide.

The method and device according to the invention enable simple and reliable online measurements of viscosity, such as determining capillary viscosity. The method and device solve problems related to increasing process rates mentioned above and significantly facilitate keeping process runnabilities stable.

In this context, online measurements refer to e.g. automatic viscosity measurements performed 1-120 times per hour. When the measurement is performed online directly from the process tanks or tubes, optimisation work is significantly accelerated when there is no need to first take a sample from the process manually, take the sample to a laboratory and, finally, measure the sample. This takes time and each step is also a risk for sources of error and becomes more costly due to the large amount of manual labour.

In online measurements, process issues caused by materials are observed considerably quicker than only by laboratory measurements, which facilitate their avoidance as well as decreases product loss and thus incurs savings. Furthermore, the measurements are automatic and thus cost-effective compared with manual work.

The method and the device can be used for measuring e.g. the following solutions or materials: nano and micro celluloses, chemicals, cosmetic creams and emulsions, medicinal creams and emulsions, paints, inks, pastes, lubrication and hydraulic oils, coatings, printing inks, paints, food products in paste and solution form, resins, and plastics. They can also be used for measuring other materials suitable for the purpose.

### BRIEF DESCRIPTION OF THE DRAWINGS

The invention will now be described in more detail with reference to the accompanying drawings in which

FIG. 1 shows an embodiment of a device according to the invention, and

FIG. 2 shows a cross section A-A of the device of FIG. 1.

### DETAILED DESCRIPTION OF THE DRAWINGS

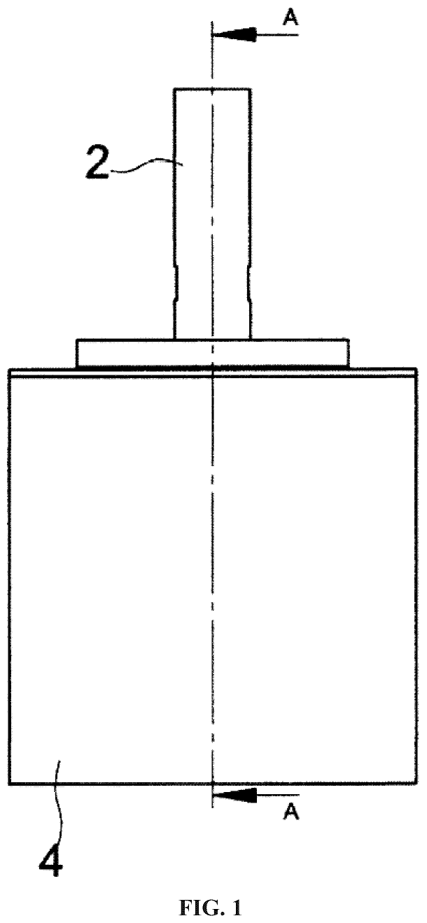

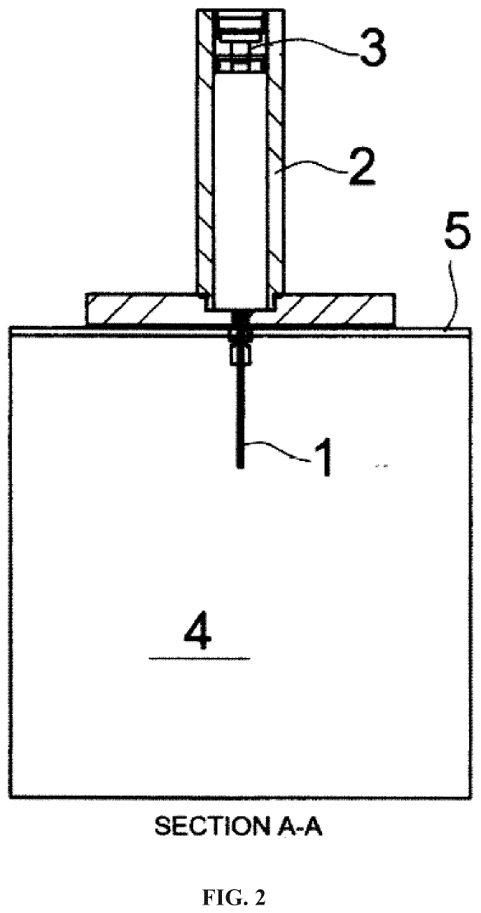

The viscometer of FIGS. 1 and 2 includes a sampling/measurement capillary tube 1 and a measuring unit 2 consisting of a cylinder 6 and a piston 3. The cylinder 6 is fastened at the point of a slit or hole manufactured to a wall 5 of a process tube 4, extending through the wall, outside the wall. The piston is moved in the cylinder in a way known as such, such as e.g. pneumatically, hydraulically or by an electric motor. In the embodiment of the figures, the measurement capillary tube 1 extends from the cylinder 6 via the hole opened to the wall 5 of the process tube 4 inside the process tube.

At the start of the measurement, the piston 3 of the cylinder 6 of the measuring unit 2 is close to or fast to the wall 5 of the process tube. The piston is being pulled within the cylinder away from the wall, whereby underpressure is created in the cylinder and the material being measured flows via the measurement capillary tube 1 to the cylinder. As for the measurement of capillary viscosity, it is performed during an opposite motion of the piston, directed at the wall, whereby the taken sample is simultaneously returned back through the wall to the process tube along the measurement capillary tube. In this case, the measurement capillary tube extending through the wall operates as both the sampling tube and the measurement capillary tube.

In other embodiments of the invention, a hole or a slit opened to the wall of a process tank, tube or equivalent operates as the capillary, which hole or slit is connected to a cylinder of a measuring unit located at the point of the hole or the slit outside the wall. Then, the slit or hole extending through the wall operates as the sampling/measurement capillary tube, and no separate measurement capillary tube is required.

The invention is not limited to the described advantageous embodiments, but it can vary within the scope of the inventive idea presented in the claims.

What is claimed is:

1. A method for measuring viscosity, in which method, running a sample of a liquid, solution, paste or equivalent being examined by means of a pressure difference from a process tube (4), tank or equivalent through a sampling/measurement capillary tube (1) to a measuring unit (2) and performing the measurement of viscosity by an opposite motion, characterised by fastening the measuring unit (2) at the point of a slit or hole manufactured to a wall (5) of the process tube (4) or tank or equivalent outside the wall (5), taking a sample automatically via the sampling/measurement capillary tube (1) extending through the wall (5) of the process tube (4), tank or equivalent directly from the process tube (4) or tank or some other part of the process cycle by means of underpressure caused by a motion of a piston (3) in a cylinder (6) of the measuring unit to the cylinder, and by performing the measurement of viscosity by an opposite motion of the piston, directed at the wall (5) of the process tube (4) or tank or equivalent, whereby the taken sample is simultaneously returned back through the wall to the process via the same sampling/measurement capillary tube (1), where the sampling/measurement capillary tube is a measurement capillary or a slit or a hole extending through the wall.

2. A method according to claim 1, characterised by cleaning the cylinder (6) of the measuring unit (2) in connection with process cleaning.

3. A device for measuring viscosity, which device includes a sampling/measurement capillary tube (1), a measuring unit (2) consisting of a cylinder (6) and a piston (3), characterised in that the measuring unit (2) is fastened at the point of a slit or a hole manufactured to a wall (5) of a process tube (4), tank or equivalent, extending through the wall (5) outside the wall and the cylinder (6) arranged to take a sample by means of underpressure caused the motion of the piston via the sampling/measurement capillary tube (1) extending through the wall directly out of the process tube (4) or tank or equivalent, arranged to measure viscosity by an opposite motion of the piston, directed at the wall (5) of the process tube (4) or tank or equivalent, and to return the sample via the sampling/measurement capillary tube (1), and that the sampling/measurement capillary tube is a measurement capillary or the slit or the hole extending through the wall.
